(19) United States
(12) Patent Application Publication
(10) Pub. No.: US 2021/0362704 A1
(43) Pub. Date: Nov. 25, 2021

(54) VALET PARKING SYSTEM AND VALET PARKING METHOD

(71) Applicant: Toyota Jidosha Kabushiki Kaisha, Toyota-shi Aichi-ken (JP)

(72) Inventor: Takanori Imazu, Susono-shi (JP)

(21) Appl. No.: 17/315,513

(22) Filed: May 10, 2021

(30) Foreign Application Priority Data
May 21, 2020 (JP) 2020-089142

(51) Int. Cl. B60W 30/06; G08G 1/14

(52) U.S. Cl. CPC B60W 30/06; G08G 1/141

(57) ABSTRACT

An AVP system comprises a parking facility and a management center. The parking facility comprises a boarding space for a passenger to get in or out of a vehicle, a path for the vehicle to travel, and a parking space for the vehicle to park. The management center manages an AVP of the vehicle in the parking facility. The management center is configured to execute traveling route calculation processing to calculate a traveling route of the vehicle in the parking facility. In the traveling route calculation processing, the traveling route including location data of nodes from a boarding space to a scheduled parking space and that of nodes to perform a swing or a turning of wheels is calculated. The location data of the nodes to perform the turning of the wheels includes that of the nodes in a vacant parking space that differs from the scheduled parking space.

### CROSS-REFERENCE TO RELATED APPLICATION

The present disclosure claims priority under 35 U.S.C. § 119 to Japanese Patent Application No. 2020-089142, filed May 21, 2020, the contents of which application are incorporated herein by reference in their entirety.

### TECHNICAL FIELD

The present disclosure relates to a system and a method to manage an AVP (Automated Valet Parking) in a parking facility.

### BACKGROUND

JP2017-182263A discloses a system to manage an AVP in a parking facility. The conventional system determines a parking space to park a vehicle based on schedule data of a passenger of the vehicle upon a loading to a parking facility associated with a facility.

### SUMMARY

Consider a case where a loading action to the parking facility includes a swing of the vehicle. This “swing” is a vehicle operation to back into the parking space that is executed in a space in front of the parking space to swing a front portion of a vehicle away from the parking space. The parking in reverse (hereinafter referred to a “reverse parking”) facilitates the vehicle operation upon an unloading from the parking facility. Therefore, it is also assumed in the AVP that a loading action including a swing is performed.

However, if the parking facility for the AVP has structural constraints, the following problem is expected. For example, if the parking space is designed to close to a dead end of a path, it is assumed that a space for the swing is narrowed. Therefore, it is also conceivable to choose not to design such a parking space. However, this is not desirable because a maximum storage capacity of the parking facility is sacrificed. Therefore, it is desirable to improve to allow the reverse parking in the parking facility having insufficient room for the swing.

One object of the present disclosure is to provide a technique that allows the reverse parking regardless of the structural constraints of the parking facility for the AVP.

A first aspect of the present disclosure is an automated valet parking system comprising a parking facility and a management center.

The parking facility comprises a boarding space for a passenger to get in or out of a vehicle, a path for the vehicle to travel, and a parking space for the vehicle to park.

The management center is configured to manage an automated valet parking of the vehicle in the parking facility.

The management center is also configured to execute traveling route calculation processing to calculate a traveling route of the vehicle in the parking facility.

In the traveling route calculation processing, the management center is configured to calculate the traveling route including location data of nodes to perform a swing of the vehicle or a turning of wheels of the vehicle as well as location data of nodes from the boarding space to a scheduled parking space into which the vehicle is scheduled to park.

The location data of the nodes to perform the turning of the wheels includes the location data of the nodes in a vacant parking space being different from the scheduled parking space.

A second aspect of the present disclosure further has the following features in the first aspect.

The management center is further configured to execute location data setting processing to set the location data of the nodes in the parking facility.

In the location data setting processing, the management center is configured to:

judge whether or not a target node to which the location data is set falls under a node in a swing avoiding space that is the parking space where a loading action including the swing is avoided; and

when it is judged that the target node falls under the node of the swing avoiding space, set the location data of the nodes to perform the turning of the wheels to the location data of the nodes in a vacant parking space being different from the location data of the nodes in the swing avoiding space.

A third aspect of the present disclosure further has the following features in the second aspect.

In the location data setting processing, when there are two or more candidates of the vacant parking space, the management center selects one of the candidates according to a predetermined reference.

A fourth aspect of the present disclosure is an automated valet parking method for a vehicle in a parking facility comprising a boarding space for a passenger to get in or out of the vehicle, a path for the vehicle to travel, and a parking space for the vehicle to park.

The method comprising a step of executing traveling route calculation processing to calculate a traveling route of the vehicle in the parking facility.

The traveling route calculation processing including a step of executing to calculate the traveling route including location data of nodes to perform a swing of the vehicle or a turning of wheels of the vehicle as well as location data of nodes from the boarding space to a scheduled parking space into which the vehicle is scheduled to park.

The location data of the nodes to perform the turning of the wheels includes the location data of the nodes in a vacant parking space being different from the scheduled parking space.

A fifth aspect of the present disclosure further has the following features in the fourth aspect.

The method further comprising a step of executing location data setting processing to set the location data of the nodes in the parking facility.

The location data setting processing comprising the steps of:

judging whether or not a target node to which the location data is set falls under a node in a swing avoiding space that is the parking space where a loading action including the swing is avoided; and

when it is judged that the target node falls under the node of the swing avoiding space, setting the location data of the nodes to perform the turning of the wheels to the location data of the nodes in a vacant parking space being different from the location data of the nodes in the swing avoiding space.

A sixth aspect of the present disclosure further has the following features in the fifth aspect.

The location data setting processing further comprising the step of, when there are two or more candidates of the vacant parking space, selecting one of the candidates according to a predetermined reference.

According to the first or fourth aspect, in the traveling route calculation processing, the traveling route in which the location data of the nodes to perform the swing or the turning of the wheels is calculated. When the former traveling route is calculated, it is possible to perform the reverse parking in which the swing is performed. When the latter traveling route is calculated, the location data of the nodes to perform the turning of the wheels includes the location data of the nodes in the vacant parking space that differs from the scheduled parking space. Therefore, when the latter traveling route is calculated, it is possible to perform the reverse parking in which the turning of the wheels in the vacant parking space is performed. Thus, it is possible to perform the reverse parking regardless of the structural constraints of the parking facility for the AVP.

According to the second or fifth aspect, when it is determined in the location data setting processing that the target node to which the location data is set falls under the node in the swing avoiding space, the location data of the nodes in the vacant parking space other than in the swing avoiding space is set to the location data of the nodes to perform the turning of the wheels. Therefore, it is possible in the traveling route calculation processing to calculate the traveling route including the location data of the nodes to perform the turning of the wheels.

According to the third or sixth aspect, when there are two or more candidates for the vacant parking space that differ from the swing avoiding space in the location data setting processing, one of the candidates is selected according to the predetermined reference. A status of the vacant parking space in the parking facility changes depending on loading actions to the parking facility and unloading actions from the parking facility. Therefore, by selecting one vacant parking space according to predetermined reference, it is possible to calculate a traveling route including the location data of the nodes in a proper vacant parking space for performing the turning of the wheels in traveling route calculation processing executed after the selection.

### BRIEF DESCRIPTION OF DRAWINGS

FIG. 1 is a diagram for illustrating an example of an AVP system;

FIG. 2 is a diagram for illustrating another example of the AVP system;

FIG. 3 is a diagram for explaining an example of a traveling route set in traveling route calculation processing;

FIG. 4 is a diagram for explaining an example of the traveling route when the loading action including the swing is performed;

FIG. 5 is a diagram for explaining an example of the traveling route when the loading action including the turning of the wheels is performed;

FIG. 6 is a diagram for explaining another example of the traveling route when the loading action including the turning of the wheels is performed;

FIG. 7 is a diagram for explaining a configuration example of a management center associated with the traveling route setting processing;

FIG. 8 is a block-diagram for explaining a functional configuration example of a management device associated with the traveling route calculation processing and location data setting processing;

FIG. 9 is a flowchart for showing a flowchart of the location data setting processing; and,

FIG. 10 is a flowchart for showing selection processing of the location data executed in processing of step S5 shown in FIG. 9.

### DESCRIPTION OF EMBODIMENTS

Hereinafter, an AVP system according to an embodiment of the present disclosure will be described with reference to drawings. The same components in the AVP system are denoted by the same sign, and descriptions thereof are omitted as appropriate.

### 1. Outline

### 1-1. Configuration of AVP System

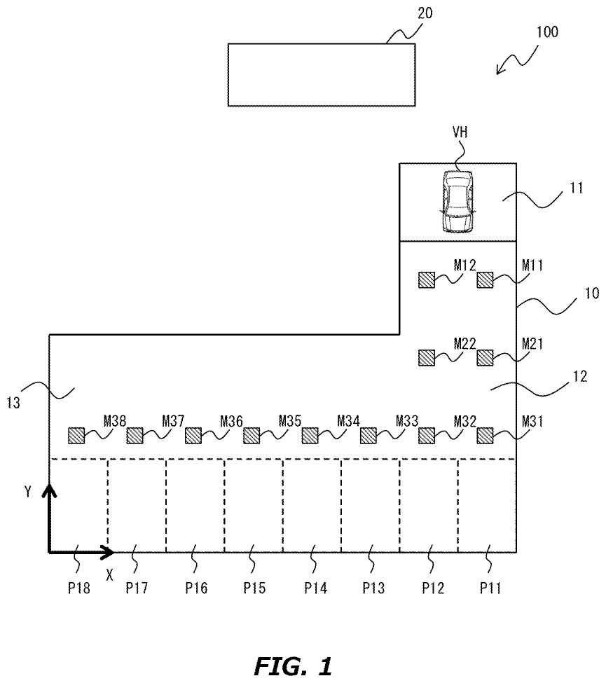

FIG. 1 is a diagram for illustrating an example of an AVP system. An AVP system 100 shown in FIG. 1 is a system to manage an AVP in a parking facility 10. The AVP system 100 includes the parking facility 10 and a management center 20.

The parking facility 10 is utilized at least for a parking a vehicle VH of which configuration is complementary with the AVP. The parking facility 10 may be utilized for the parking of general vehicles other than the vehicle VH. The parking facility 10 includes a boarding space 11, a path 12, parking spaces P11 to P18, and landmarks M11 to M38.

The boarding space 11 is a space in which a passenger of the vehicle VH gets in or out of the vehicle VH. The boarding space 11 may be installed in two or more places in the parking facility 10. The boarding space 11 may be divided into a space for the passenger to get in the vehicle VH and a space for the passenger to get out of the vehicle VH.

The path 12 is a space for the vehicle VH to travel. One end of the path 12 is connected to the boarding space 11. The other end of the path 12 is a dead end 13. The dead end 13 results from a construction of the parking facility 10 (e.g., walls, fences, struts and braces). An obstacle other than the construction may form the dead end 13 (e.g., a mark indicating an area where a travel by a vehicle is prohibited).

The landmarks M11 to M38 are installed on the path 12. Each of the landmarks M11 to M38 is a reference position to guide the vehicle VH. Each location data DM of the landmarks M11 to M38 is represented by relative coordinate system numerical values (X, Y). In the example shown in FIG. 1, each of the landmarks M31 to M38 is provided corresponding to each of parking spaces P11 to P18.

Each of the parking spaces P11 to P18 is a space to park the vehicle VH and the general vehicles. The parking spaces P11 to P18 are separated by compartment lines. Landmarks may be provided inside each of the parking spaces P11 to P18.

The management center 20 grasps usage situations (e.g., an empty situation and a congestion situation) of the parking facility 10. The management center 20 also uses a recognition device (e.g., a camera and a sensor) installed in the parking facility 10 to monitor movements and states of the vehicle VH in the parking facility 10. In addition, the management center 20 communicates with the vehicle VH and manages a loading action from the boarding space 11 to a scheduled parking space and an unloading action from an actual parking space to the boarding space 11. The “scheduled parking space” is a parking space into which the vehicle VH is scheduled to be parked. The “actual parking space” is a parking space in which the vehicle VH is actually parked.

The management of the loading and unloading actions by the management center 20 also includes the management of an automated travel of the vehicle VH on the path 12. The processing for the automated travel is basically executed in an AVP support kit (not shown) mounted on the vehicle VH. However, the management center 20 may remotely control the vehicle VH via a communication device. In this instance, the processing for the automated travel may be executed in the management center 20.

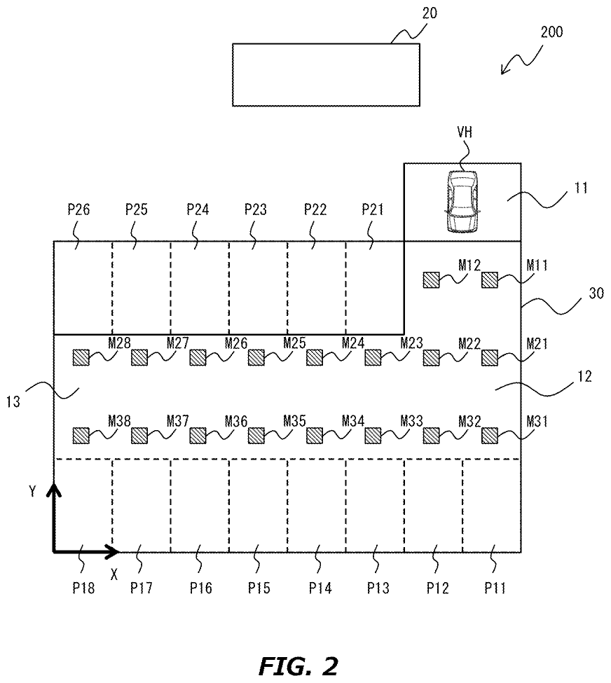

FIG. 2 is a diagram for illustrating another example of the AVP system. An AVP system 200 shown in FIG. 2 differs from the AVP 100 shown in FIG. 1 in the configuration of the parking facility. Specifically, the AVP system 200 includes a parking facility 30. The parking facility 30 further includes parking spaces P21 to P26 in addition to the configuration of the parking facility 10 described in FIG. 1. Landmarks M23 to M28 are further installed on the path 12 of the parking facility 30. Each of the landmark M23 to M28 is provided corresponding to each of the parking spaces P23 to P26.

### 1-2. Traveling Route

As a part of a management of the automated travel of vehicle VH on the path 12, the management center 20 executes “traveling route calculation processing” to calculate a traveling route of the vehicle VH in the parking facility 10 (or the parking facility 30. The same applies to the following). The traveling route TR at the loading to the parking facility 10 is contains location data NOD of nodes N from the boarding space 11 to the scheduled parking space. Each of the location data NOD is represented by the relative coordinate system numerical values (X, Y). The traveling route at the unloading from the parking facility 10 contains the location data NOD from the actual parking space to the boarding space 11.

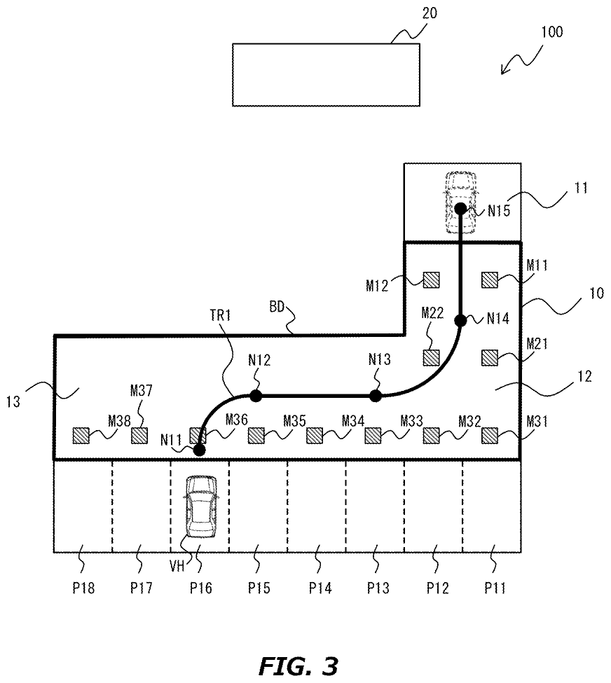

FIG. 3 is a diagram for explaining an example of a traveling route set in the traveling route calculation processing. The traveling route TR1 shown in FIG. 3 is the traveling route TR at the unloading from the parking facility 10. The actual parking space of the traveling route TR1 is the parking space P16. The traveling route TR1 contains the location data NOD of the nodes N11 to N15.

The node N11 is the node N indicating a position at which the vehicle VH from the parking space P16 starts a clockwise turning. The node N12 is the node N indicating a position at which this clockwise turning is finished and a straight-ahead is started. The node N13 is the node N indicating a position at which this straight-ahead is finished and a counter-clockwise turning is started. The node N14 is the node N indicating a position at which this counter-clockwise turning is finished and another straight-ahead is started. The node N15 is the node N indicating a position at which this straight-ahead is finished and the vehicle VH stops.

Each location data NOD of the nodes N11 to N15 includes at least one location data DM of a landmark M that locates around each of the nodes N. Each of the location data NOD of the nodes N11 to N15 further includes location data DBD of a traveling boundary BD that locates around each of the nodes N. Each of the location data DBD is represented by the relative coordinate system numerical values (X, Y). Typically, the location data DBD that locates around the node N is represented as a collection of at least two numerical values (X, Y).

For example, the location data NOD of the node N11 includes the location data DM of the landmark M36 and at least two location data DBD that locate around the parking space P16. The location data NOD of the node N12 includes the location data DM of the landmark M35 and at least two location data DBD that locate around the landmark M35. The location data NOD of the node N15 includes the location data DM of the landmarks M11 and M12 and at least two location data DBD that locate around the boarding space 11.

Here, the traveling boundary BD is typically formed by an outer edge of the path 12. In the parking space, if a vehicle length of the vehicle VH parked in the parking space is long, the traveling boundary BD may be formed inside this outer edge. The location data DBD is updated by the management center 20, for example, each time the loading of a vehicle (i.e., the vehicle VH or the generic vehicle) to the parking facility 10 is completed or the unloading of the vehicle from the parking facility 10 is completed. The location data DBD is updated using data from the recognition device.

### 1-3. Traveling Route to Perform the Loading Action Including the Swing

The traveling route TR1 described in FIG. 3 is realized by the reverse parking performed at the loading to the parking facility 10. In the present embodiment, it is considered that the swing of the vehicle VH is performed for the reverse parking. Hereinafter, the traveling route to perform the loading action including the swing in the traveling route calculation processing will be described.

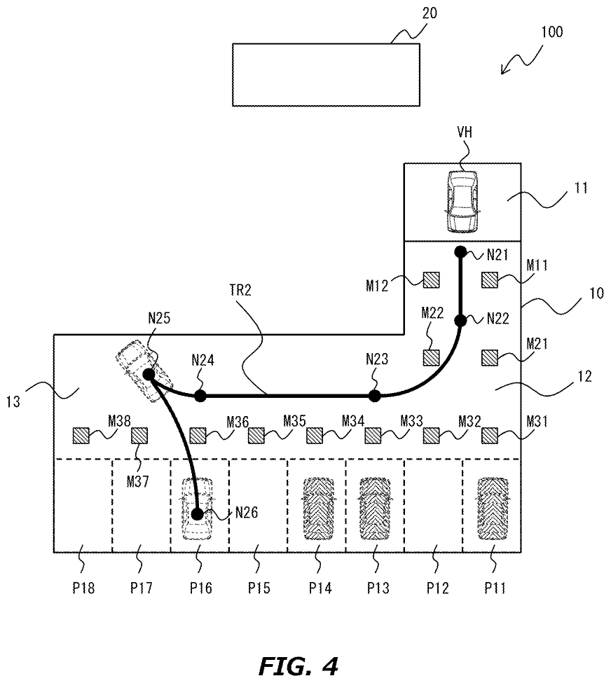

FIG. 4 is a diagram for explaining an example of the traveling route when the loading action including the swing is performed. The traveling route TR2 shown in FIG. 4 is the traveling route TR at the loading to the parking facility 10. The scheduled parking space of the traveling route TR2 is the parking space P16. The traveling route TR2 contains the location data NOD of the nodes N21 to N26.

The node N21 is the node N indicating an entrance of the path 12. The node N22 is the node N indicating a position at which the vehicle VH starts the clockwise turning. The node N23 is the node N indicating a position at which this clockwise turning is finished and straight-ahead is started. The node N24 is the node N indicating a position at which this straight-ahead is finished and swing is started. The node N25 is the node N indicating a position at which this swing is finished and the reverse parking is started. The node N26 is the node N indicating a position at which the reverse parking is finished and the vehicle stops.

Basic concept in the location data NOD of the nodes N21 to N26 is the same as that of the location data NOD of the nodes N11 to N15 described in FIG. 3. For convenience of explanation, the location data NOD corresponding to the position at which the swing is started is referred to as “location data NOD_{SW}.” If the location data NOD_{SW} is set, this location data NOD_{SW} is treated as unique data of the traveling route TR. Specifically, the location data NOD of the node N24 described in FIG. 4 apply to the unique data when the traveling route TR2 is calculated.

### 1-4. Features of Embodiment

In the swing described in FIG. 4, the space that locates in front of the parking space P17 (i.e., a part of the path 12), was used. However, when area of the path 12 is limited, a case is assumed in which it is difficult to secure a space to perform the swing. In particular, the swing may not be possible at the parking space P17 and P18 close to the dead end 13. Therefore, in order to perform the reverse parking to such a parking space, the node N indicating a position at which a turning of wheels of the vehicle VH is set in the present embodiment.

Here, “the turning of the wheels” generally means to reposition the vehicle by a forward or backward movement. However, the “turning of the wheels” in the present embodiment means a vehicle operation including an anterior half operation and a posterior half operation. In the anterior half operation, the vehicle VH moves forward to a vacant parking space differing from the scheduled parking space thereby at least a part of the vehicle VH is placed inside the vacant parking space. In the posterior half operation, the vehicle moves backward to head to the scheduled parking space. Hereinafter, the traveling route to perform the loading action including the turning of the wheels in the traveling route calculation processing will be described.

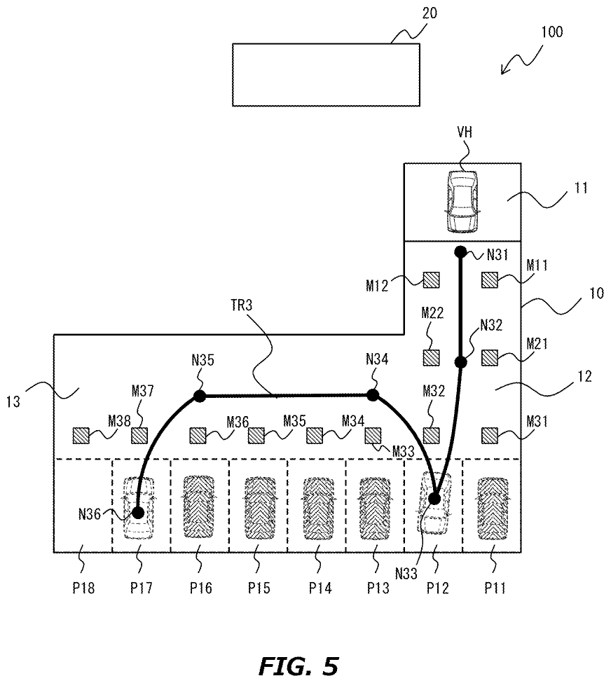

FIG. 5 is a diagram for explaining an example of the traveling route when the loading action including the turning of the wheels is performed. The traveling route TR3 shown in FIG. 5 is the traveling route TR at the loading to the parking facility 10. In the example shown in FIG. 5, the vacant parking space corresponds to the parking spaces P12, P17 and P18. However, the parking space P17 is selected as the scheduled parking space in the traveling route TR3. The traveling route TR3 contains the location data NOD from the nodes N31 to N36.

The node N31 is the node N indicating the entrance of the path 12. The node N32 is the node N indicating a position at which the anterior half operation of the turning of the wheels is started. This anterior half operation is the vehicle operation in which the vehicle VH is placed in the vacant parking space (i.e., the parking space P12). The node N33 is the node N indicating a position at which the anterior half operation is finished and the posterior half operation is started. This posterior half operation is the vehicle operation to move backward while swinging a rear portion of the vehicle VH toward the scheduled parking space (i.e., the parking space P17). The node N34 is the node N indicating a position at which steering of the posterior half operation is finished. The node N35 is the node N indicating a position at which the reverse parking is started. The node N36 is the node N indicating a position at which the reverse parking is finished and the vehicle stops.

Basic concept in the location data NOD of the nodes N31 to N36 is the same as that of the location data NOD of nodes N11 to N15 described in FIG. 3. For convenience of explanation, the location data NOD corresponding to the position at which the turning of the wheels is performed is referred to as “location data NOD_{TW}.” The meaning of the location data NOD_{TW} is the same as that of the location data NOD_{SW}. That is, the location data NOD of the nodes N32 to N34 described in FIG. 5 correspond to the unique data when the traveling route TR3 is calculated.

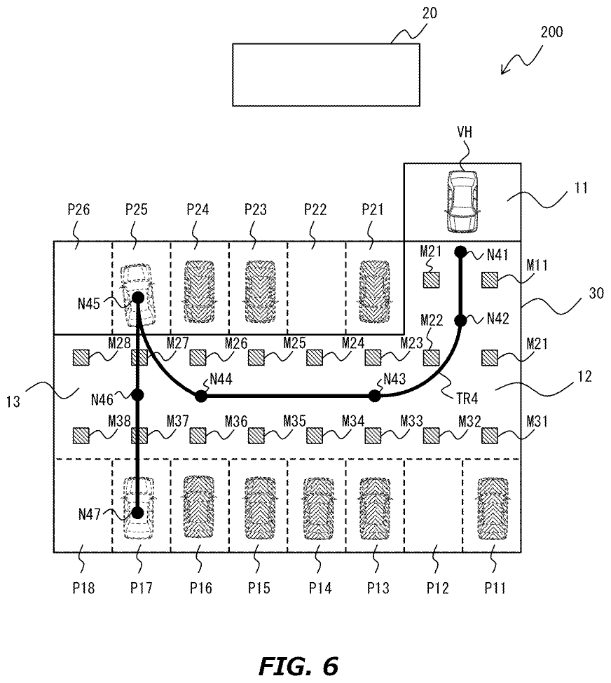

FIG. 6 is a diagram for explaining another example of the traveling route when the loading action including the turning of the wheels is performed. The traveling route TR4 shown in FIG. 6 is the traveling route TR at the loading. The difference between the example shown in FIG. 5 and that shown in FIG. 6 lies in the configuration of the parking facility and in the vacant parking space used for the turning of the wheels. In the example shown in FIG. 6, the vacant parking space corresponds to the parking spaces P12, P17, P18, P22 and P26. However, the parking space P17 is selected as the scheduled parking space in the traveling route TR4. The traveling route TR4 contains the location data NOD of the nodes N41 to N47.

The nodes N41 to N43 are the same as the nodes N21 to N23 described in FIG. 4. The node N44 is the node N indicating a position at which the anterior half operation of the turning of the wheels is started. This anterior half operation is a vehicle operation in which the vehicle VH is placed in the vacant parking space (i.e., the parking space P25). The node N45 is the node N indicating a position at which the anterior half operation is finished and the posterior half operation is started. The posterior half operation is the vehicle operation to move backward while swinging a rear portion of the vehicle VH toward the scheduled parking space (i.e., the parking space P17). The node N46 is the node N indicating a position at which the swing of the posterior half operation is finished and the reverse parking is started. The node N47 is the node N indicating a position at which the reverse parking is finished and the vehicle stops.

Basic concept in the location data NOD of the nodes N41 to N47 is the same as that of the location data NOD of nodes N11 to N15 described in FIG. 3. Note that the location data NOD of the nodes N44 to N46 described in FIG. 6 corresponds to unique location data NOD_{TW} when the traveling route TR4 is calculated.

As described above, in the traveling route setting processing, the traveling route TR to perform the loading action including the swing or the turning of the wheels is set. For this reason, for example, the former is set when there is a space to perform the swing, and the latter is set when there is no a space to perform the swing. In another example, the latter is set any time when the traveling route TR is set. That is, in this alternative example, the turning of the wheels is incorporated into every loading action. According to the setting of the traveling route TR, it is possible to perform the reverse parking at all times without being limited to structural constraints of the parking facility. The following describes a configuration example of the management center 20 to set such the traveling route TR and a processing example executed by the management center 20.

### 2. Management Center

### 2-1. Configuration of Management Center

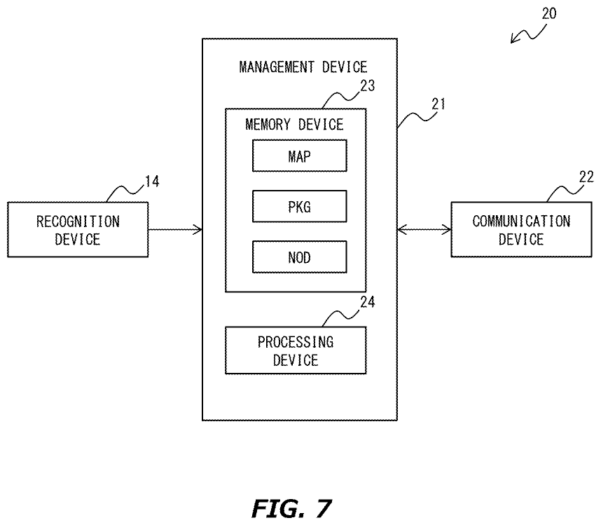

FIG. 7 is a diagram for explaining a configuration example of the management center 20 associated with the traveling route setting processing. In the example shown in FIG. 7, the management center 20 comprises a management device 21 and a communication device 22.

The management device 21 is typically a computer comprising at least one processing device, at least one memory device, and an input and output interface. FIG. 7 depicts a memory device 23 and a processing device 24 of these elements. The memory device 23 stores various data related to the AVP. Examples of the various data include situation data PKG of the parking facility 10, map data MAP of the parking facility 10 and location data NOD.

Examples of the map data MAP include location data of a construction in the parking facility 10. Examples of the map data MAP also include, location data of a facility in the parking facility 10 (i.e., the landmark M, the traveling boundary BD, and the recognition device 14). Examples of the map data MAP also include, location data of compartment lines in the parking space. Each of these location data is represented by the relative coordinate system numerical values (X, Y). Height data may be added to the location data.

Examples of the situation data PKG include data from the recognition device 14. The data from the recognition device 14 includes the location data of the vehicle VH that performs the AVP and the location data of the vehicle VH that stops in the boarding space 11 or the parking space. Each of these location data is also represented by the relative coordinate system numerical values (X, Y). The data from the recognition device 14 also includes the location data DBD.

The location data NOD is set for each node N. For convenience of explanation, any location data NOD or any node N in which any node N is set when the location data NOD is set is collectively referred to as a “node Ni.” The location data NOD includes the location data DM and the location data DBD that locate around the node Ni. The location data DM is extracted from the map data MAP and associated with the node Ni. That is, the location data DM is tied to the node Ni. The location data DBD is extracted from the map data MAP or the situation data PKG and associated with node Ni. That is, location data DBD is also tied to the node Ni.

The processing device 24 processes various data according to various programs stored in the memory device 23. The processing executed by the processing device 24 includes the traveling route calculation processing. The processing executed by the processing device 24 also includes “location data setting processing” in which the location data NOD is set. Details of the location data setting processing will be described later. The processing executed by the processing device 24 also includes processing to transmit and receive data to and from the vehicle VH via the communication device 22. The data transmitted to the vehicle VH includes the traveling route TR calculated by the traveling route calculation processing.

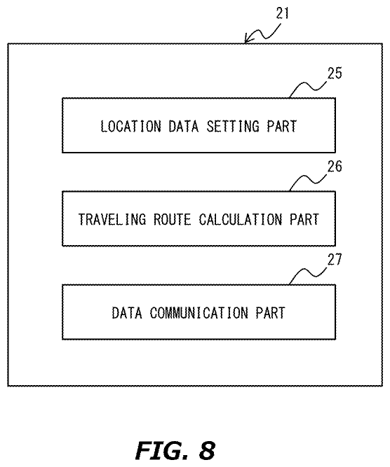

FIG. 8 is a block-diagram for explaining a functional configuration example of a management device 21 associated with the traveling route calculation processing and location data setting processing. As shown in FIG. 8, the management device 21 includes a location data setting part 25, a traveling route calculation part 26 and a data communication part 27. Note that these functions is realized when the processing device 24 described in FIG. 7 executes a predetermined program stored in the memory device 23.

The location data setting part 25 executes the location data setting processing based on the map data MAP and the situation data PKG. In the location data setting processing, at least one of the location data DM and DBD is associated with the node Ni that is a target to which the location data NOD is set. In the location data setting processing, also, the location data NOD_{SW} or NOD_{TW} is associated with the target to which the location data NOD is set. The location data setting part 25 transmits the location data NOD that is set by the location data setting processing to the memory device 23. A processing example of the location data setting processing will be described later.

The location data setting processing is executed not only when the map data MAP is initially set but also when the map data MAP is updated. As mentioned above, the map data MAP includes the location data DBD. In the present embodiment, when the location data DBD is updated, the map data MAP is also updated. Therefore, when the location data DBD is updated, the location data setting processing is executed. The location data setting processing is also executed when the situation data PKG is updated.

The target to which the location data NOD is set in the location data setting processing corresponds to all node N in the parking facility 10. However, if the map data MAP or the situation data PKG is updated only in some areas of the parking facility 10, in order to reduce processing load, only nodes N of these areas may be selected as the target to which the location data NOD is set. That is, if the map data MAP or situation data PKG has not been updated in some area of the parking facility 10, the nodes N of these areas may be excluded from the target to which the location data NOD is set.

The traveling route calculation part 26 executes the traveling route calculation processing based on the map data MAP and situation data PKG. In the traveling route calculation processing, the traveling route TR of the vehicle VH as an object of the unloading or loading action is calculated. In the traveling route calculation processing upon the loading to the parking facility 10, one of the vacant parking space is selected as the scheduled parking space. The method of selecting this scheduled parking space is not particularly limited, and a known method is applied. The traveling route calculation part 26 transmits the traveling route TR calculated by the traveling route calculation processing to the data communication part 27.

The data communication part 27 receives data from the recognition device 14. The data communication part 27 transmits and receives data to and from the communication device 22. The data transmitted from the data communication part 27 to the communication device 22 includes the location data NOD composing the traveling route TR calculated by the traveling route calculation processing. The data communication part 27 stores the data received from the recognition device 14 and communication device 22 in the memory device 23. The data communication part 27 may transmit data received from the recognition device 14 and communication device 22 directly to the location data setting part 25 and the traveling route calculation part 26.

### 2-2. Location Data Setting Processing

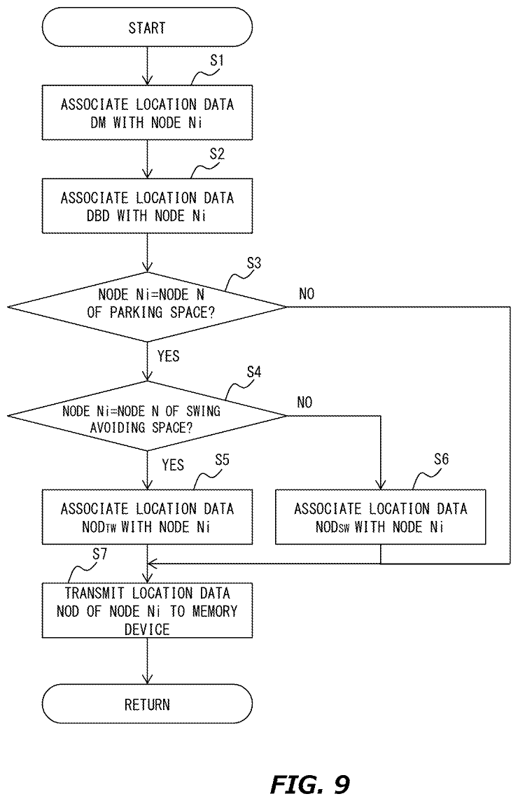

FIG. 9 is a flowchart for showing a flowchart of the location data setting processing executed by the processing device 24. The routine shown in FIG. 9 is executed when the map data MAP is initialized or updated or when the situation data PKG is updated. The routine shown in FIG. 9 is repeated until the location data NOD is set for all of the nodes N in the parking facility 10. The execution of the routine shown in FIG. 9 may be limited to the nodes N of the some areas of the parking facility 10 for which the map data MAP or situation data PKG has been updated.

In the routine shown in FIG. 9, first, the location data DM is associated with the node Ni that is the target to which the location data NOD is set (step S1). This location data DM corresponds to that whose distance from the target to which the location data NOD is set is a threshold THM or less. There is at least one location data DM is associated with the target to which the location data NOD is set.

Subsequent to the step S1, the location data DBD is associated with the node Ni as the target to which the location data NOD is set (step S2). This location data DBD corresponds to that whose distance from the target to which the location data NOD is set is equal to or less than a threshold THBD. There is at least two location data DBD is associated with the target to which the location data NOD is set.

Subsequent to the step S2, it is judged whether or not the node Ni as the target to which the location data NOD is set corresponds to the node N of the parking space (step S3). If the node Ni locates in the parking space, the node Ni corresponds to the node N in the parking space. Whether or not the node Ni locates in the parking space is judged, for example, based on the location data of the compartment line of the parking space (i.e., the map data MAP). If the judgement result of the step S3 is negative, process proceed to step S7.

If the judgement result in the step S3 is positive, it is judged whether or not the node Ni as the target to which the location data NOD is set corresponds to the node N of a swing avoiding space (step S4). The “swing avoiding space” means a node N of the parking space at which there is insufficient room for the swing. For example, if the area of the path 12 that locates in front of the parking space is equal to or less than a threshold THS, this parking space corresponds to the swing avoiding space. In another example, if a distance from the dead end 13 to the parking space is equal to or less than a threshold THE, this parking space corresponds to the swing avoiding space. The judgement of the step S4 may be executed by appropriately combining a size of the vehicle VH (i.e., vehicle length and vehicle width).

If the judgement result of the step S4 is positive, it is estimated that the loading action including the turning of the wheels is appropriate. Therefore, in this case, the location data NOD_{TW} is associated with the node Ni as the target to which the location data NOD is set (step S5). Otherwise, the parking space is estimated to be a space in which the swing is recommended. Therefore, in this case, the location data NOD_{SW} is associated with the node Ni as the target to which the location data NOD is set (step S6).

In the step S7, the location data NOD that is associated with the node Ni in the process of this routine is transmitted to the memory device. That is, if the node Ni corresponds to the node N of the swing avoiding space, the location data NOD including the location data DM, DBD and NOD_{TW} is transmitted to the memory device. If the node Ni corresponds to the node N of the space in which the swing is recommended, the location data NOD including the location data DM, DBD and NOD_{SW} is transmitted to the memory device. If the node Ni does not correspond to the node N of the parking space, the location data NOD including the location data DM and DBD is transmitted to the memory device.

When the turning of the wheels is set for all of the parking spaces, the processing of the steps S4 and S6 may be omitted. In this case, the processing of the step S7 will be described as follows. That is, if the node Ni is the node N of the parking space, the location data NOD including the location data DM, DBD and NOD_{TW} is transmitted to the memory device. If the node Ni does not correspond to the node N of the parking space, the location data NOD including the location data DM and DBD is transmitted to the memory device.

### 2-3. Selection Method of Location Data NOD_{TW}

In the processing of the step S5, it was explained that the location data NOD_{TW} is associated with the node Ni that is the target to which the location data NOD is set. However, the situation of the vacant parking space in the parking facility 10 varies depending on the loading and unloading action of the vehicle VH. Therefore, in the processing of the step S5, each time at which the location data setting processing is executed, processing to associate a proper location data NOD_{TW} with the node Ni is executed in a sub-routine. This processing if the sub-routine will be described below.

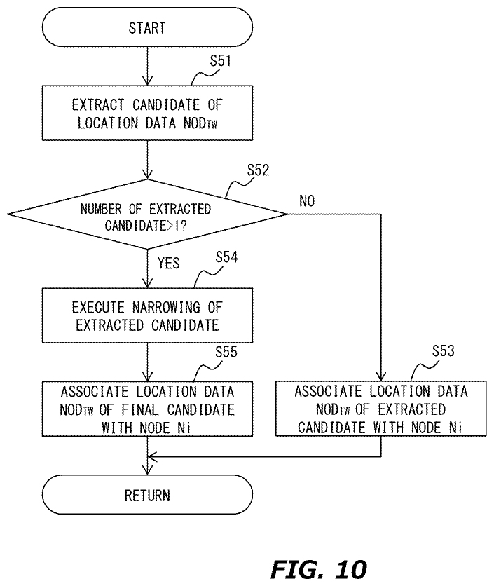

FIG. 10 is a flowchart for showing selection processing of the location data NOD_{TW} executed in the processing of the step S5 shown in FIG. 9. In order to perform the loading action including the turning of the wheels, a vacant parking space different from scheduled parking space is required. Therefore, when only one vacant parking space remains at the loading to the parking facility 10, the processing of this routine is not executed.

In the routine shown in FIG. 10, first, at least one candidate of the location data NOD_{TW} is extracted (step S51). This candidate corresponds to all node N of the vacant parking space remaining at the execution of the processing of the step S5. Note that the node Ni as the target to which the location data NOD is set corresponds to the node N of the scheduled parking space. Therefore, the node Ni as the target to which the location data NOD is set does not correspond to the vacant parking space in the step S51.

Subsequent to the step S51, it is judged whether or not the number of the extracted candidate of the location data NOD_{TW} is two or more (step S52). If the judgement result of the step S52 is negative, that is, if the number of the extracted candidate is one, the location data NOD_{TW} of the extracted candidate is associated with the node Ni as the target to which the location data NOD is set (step S53).

If the judgement result of the step S52 is positive, the candidates for the location data NOD_{TW} are narrowed down (step S54). The candidates are narrowed down according to a predetermined reference. The predetermined reference includes, for example, increasing a priority of the node N whose distance is within a predetermined range from the node Ni as the target to which the location data NOD is set. This predetermined range is set in consideration of an easiness of the vehicle operation performed before and after the turning of the wheels. In another example, the predetermined reference includes increasing a priority of the node N that reduces the number of other vehicles that have a potential to cross in front of the vehicle VH during the vehicle VH performs the turning of the wheels. A small number of the other vehicles means that there are few obstacles around the vehicle VH during the vehicle VH performs the turning of the wheels. Such the narrowing based on the predetermined reference makes it possible to facilitate the vehicle operation performed before and after the turning of the wheels.

The processing of the step S54 is executed until the candidates are narrowed down to one. The candidate selected after the narrowing become a final candidate. In the step S55, the location data NOD_{TW} of the final candidate is associated with the node Ni as the target to which the location data NOD is set (step S55).

### 3. Effect

According to the AVP system of the present embodiment, described above, the location data setting processing is executed. According to the location data setting processing, the location data NOD_{SW} or NOD_{TW} is associated with the location data NOD of the node Ni of the parking space. Therefore, in the traveling route calculation processing at the loading to the parking facility 10, it is possible to set the traveling route TR to perform the loading action including the swing or the turning of the wheels. Therefore, it is possible to perform the reverse parking at all times without being limited to the structural constraints of the parking facility 10. Therefore, it is possible to facilitate the vehicle operation at the unloading from the parking facility 10 and shorten time required for the unloading action. This is expected to contribute to improve utilization rate of an AVP services.

What is claimed is:

1. An automated valet parking system, comprising:
a parking facility comprising a boarding space for a passenger to get in or out of a vehicle, a path for the vehicle to travel, and a parking space for the vehicle to park; and
a management center which manages an automated valet parking of the vehicle in the parking facility,
wherein the management center is configured to execute traveling route calculation processing to calculate a traveling route of the vehicle in the parking facility,
wherein, in the traveling route calculation processing, the management center is configured to calculate the traveling route including location data of nodes to perform a swing of the vehicle or a turning of wheels of the vehicle as well as location data of nodes from the boarding space to a scheduled parking space into which the vehicle is scheduled to park,
wherein the location data of the nodes to perform the turning of the wheels includes the location data of the nodes in a vacant parking space being different from the scheduled parking space.

2. The automated valet parking system according to claim 1,
wherein the management center is further configured to execute location data setting processing to set the location data of the nodes in the parking facility,
wherein, in the location data setting processing, the management center is configured to:
judge whether or not a target node to which the location data is set falls under a node in a swing avoiding space that is the parking space where a loading action including the swing is avoided; and
when it is judged that the target node falls under the node of the swing avoiding space, set the location data of the nodes to perform the turning of the wheels to the location data of the nodes in a vacant parking space being different from the location data of the nodes in the swing avoiding space.

3. The automated valet parking system according to claim 2,
wherein, in the location data setting processing, the management center is further configured to, when there are two or more candidates of the vacant parking space, select one of the candidates according to a predetermined reference.

4. An automated valet parking method for a vehicle in a parking facility comprising a boarding space for a passenger to get in or out of the vehicle, a path for the vehicle to travel, and a parking space for the vehicle to park, the method comprising a step of executing traveling route calculation processing to calculate a traveling route of the vehicle in the parking facility,
wherein the traveling route calculation processing including a step of executing to calculate the traveling route including location data of nodes to perform a swing of the vehicle or a turning of wheels of the vehicle as well as location data of nodes from the boarding space to a scheduled parking space into which the vehicle is scheduled to park,
wherein the location data of the nodes to perform the turning of the wheels includes the location data of the nodes in a vacant parking space being different from the scheduled parking space.

5. The automated valet parking method according to claim 4, further comprising the step of executing location data setting processing to set the location data of the nodes in the parking facility,
wherein the location data setting processing comprising the steps of:
judging whether or not a target node to which the location data is set falls under a node in a swing avoiding space that is the parking space where a loading action including the swing is avoided; and
when it is judged that the target node falls under the node of the swing avoiding space, setting the location data of the nodes to perform the turning of the wheels to the location data of the nodes in a vacant parking space being different from the location data of the nodes in the swing avoiding space.

6. The automated valet parking method according to claim 5,
wherein the location data setting processing further comprising the step of, when there are two or more candidates of the vacant parking space, selecting one of the candidates according to a predetermined reference.
